(19) United States
(12) Patent Application Publication
(10) Pub. No.: US 2004/0226906 A1
(43) Pub. Date: Nov. 18, 2004

(54) Baby bottle nipple

(76) Inventor: Johan Peterson, Streamwood, IL (US)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/435,762

(22) Filed: May 12, 2003

(51) Int. Cl. A61J 9/04

(52) U.S. Cl. 215/11.5

(57) ABSTRACT

An improved baby bottle nipple with a vent comprising a microporous membrane sealed within a membrane holder, which is then inserted into a wall of the nipple. The microporous membrane permits air to pass through to the baby bottle to relieve negative pressure within the bottle but does not permit the liquid within the bottle to leak out of the bottle. The hard material of the membrane holder allows for ease in removing, cleaning, and replacing the vent.

### BACKGROUND OF THE INVENTION

This invention relates to an improved nipple for relieving negative pressure in a baby bottle. The use of nipples on bottles to nourish infants, human or animal, is well-known. The sucking action of the infant, however, creates a negative pressure in the bottle, which causes the nipple to collapse, sealing off the bottle and stopping the flow of the contents. This disruption in feeding is unexpected by the infant and is likely to cause disharmony when the nurser removes the bottle to remedy the situation. The infant's continued attempts at sucking will only draw ambient air, not liquid from the bottle, causing gas build-up inside the baby.

A variety of methods have been utilized to relieve the negative pressure caused by a baby's sucking the contents of a bottle. One common solution is to avoid the issue altogether by using a collapsible bag for the container, such as the Playtex Disposable Easy Feed Nurser. This solution requires complex preparation steps by the user. Accordingly, a simpler way to relieve pressure is needed. Various mechanical methods have been employed, such as U.S. Pat. No. 5,499,729 to Greenwood, which describes a complex diaphragm arrangement. These methods are complex to manufacture and use. Other methods include adjustable air inlet passages, as described in U.S. Pat. No. 5,244,105 to Serre and U.S. Pat. No. 2,942,746 to Porthouse. These methods require action by the user. Other methods include providing vents in the bottle itself, as described in U.S. Pat. No. 4,865,207 to Joyner and U.S. Pat. No. 6,398,048 to Kevorkian. Other methods include simply placing a hole in the nipple to allow for the passage of air, as in U.S. Pat. No. 6,371,315 to Chien. These methods tend to leak and are often difficult to clean.

Accordingly, a need exists for a self-venting baby bottle nipple that avoids the problems of the prior art.

### BRIEF SUMMARY OF THE INVENTION

In accordance with the foregoing, the present invention comprises a baby bottle nipple manufactured from a moldable thermoplastic such as silicon rubber, and having a removable vent comprising a microporous membrane sealed into a vent holder, which is releasably insertable into the base section of the nipple itself. The microporous membrane prevents the flow of liquid out of the container but permits the flow of air into the container, thereby equalizing the negative pressure created in the bottle with the ambient air pressure. This equalization allows the nipple to maintain its shape, allowing liquid to flow through to the infant and preventing disruption in feeding. The removable nature of the vent allows for easy cleaning.

### BRIEF DESCRIPTION OF THE SEVERAL VIEWS OF THE DRAWING

The organization and manner of the structure and operation of the invention, together with further objects and advantages thereof, may best be understood by reference to the following description, taken in connection with the accompanying drawings:

FIG. 1 is a cross-sectional elevation view of the nipple of the preferred embodiment of the present invention.

FIG. 2 is a cross-sectional elevation view of the base section of the nipple of the preferred embodiment of the present invention.

FIG. 3 is an enlargement of FIG. 2.

FIG. 4 is a cross-sectional elevation view of the vent of the preferred embodiment of the present invention.

FIG. 5 is a cross-sectional plan view of the vent of the preferred embodiment of the present invention.

### DETAILED DESCRIPTION OF THE INVENTION

While the invention may be susceptible to embodiments in different forms, there is shown in the drawings, and herein will be described in detail, a specific embodiment with the understanding that the present disclosure is to be considered an exemplification of the principles of the invention, and is not intended to limit the invention to that as illustrated and described herein. For example, the following portion of the specification describes the invention as used for a human baby bottle. The invention can be used as well for feeding nursing animals, as well as for any type of liquid dispensation in which self-venting is required or desired.

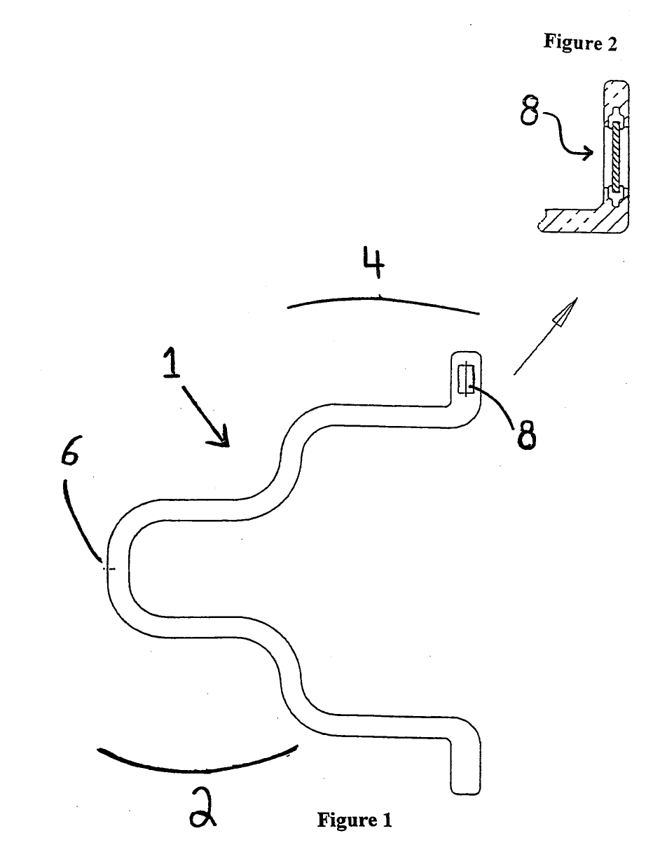

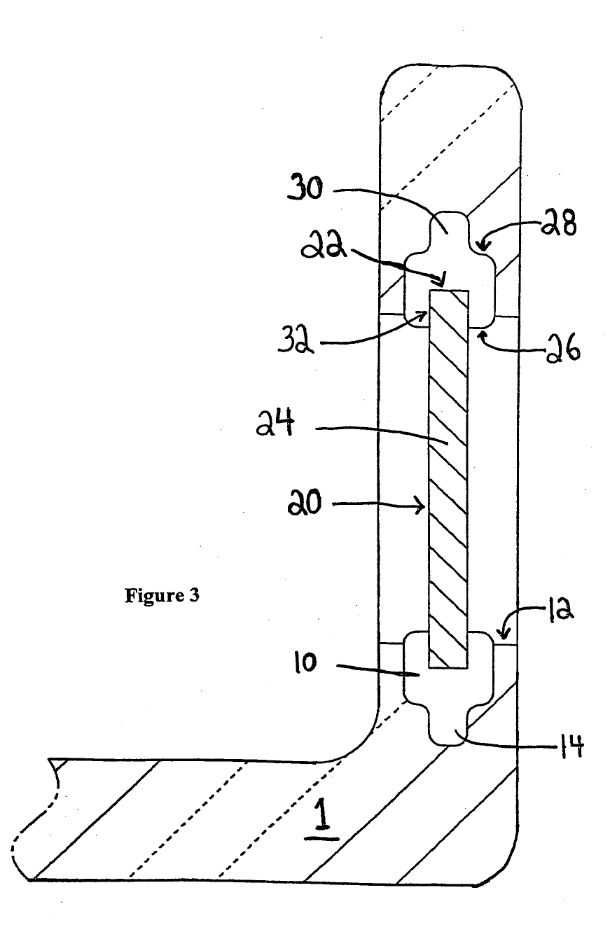

FIG. 1 is a cross-sectional elevation view of the preferred embodiment of the nipple 1 of the present invention. The nipple 1 is preferably made of silicone rubber, but can be made of any material that is flexible, able to provide a pleasing feeling to the infant, and nontoxic. The nipple 1 generally has a teat section 2 and a base section 4. The teat section 2, having a hole 2 for passage of fluid such as milk, is inserted into the infant's mouth, while the base section 4 is used to attach the nipple 1 to a bottle or other suitable container. The method of attachment of the nipple 1 to the bottle is known to the art and is not part of the present invention. (For example, see U.S. Pat. No. 6,398,048 to Kevorkian.) For purposes of the present invention, the method of attachment is not critical so long as that method creates a sufficient seal between the nipple 1 and the bottle and does not block the vent 20, as hereinafter described.

The nipple 1 also has a vent aperture 8. In the preferred embodiment, the vent aperture 8 is located in the lower, horizontal portion of the base section 4, as illustrated, but it can be located anywhere in that section. The vent aperture 8 is preferably formed as part of the molding process but can be bored into the nipple 1, cut from the material of the nipple 1, or otherwise formed in any manner found convenient. In the preferred embodiment, the vent aperture 8 further comprises an annular vent channel 10 in the walls 12 of the vent aperture 8 to provide a tighter seal between the nipple 1 and the vent 20, as hereinafter described. As illustrated, the vent channel 10 also comprises a further annular vent groove 14 to provide an even more secure seal.

The vent 20 comprises a membrane holder 22 and a porous membrane 24. The porous membrane 24 is a microporous material. Any microporous membrane can be used, so long as it meets the requirements of permitting the passage of air and resisting the passage of liquids. In the preferred embodiment, the membrane is made of expanded PTFE, for example, W. L. Gore & Associates, Inc. Part Number L31779, medical membrane made of expanded PTFE with nonwoven polyester membrane support.

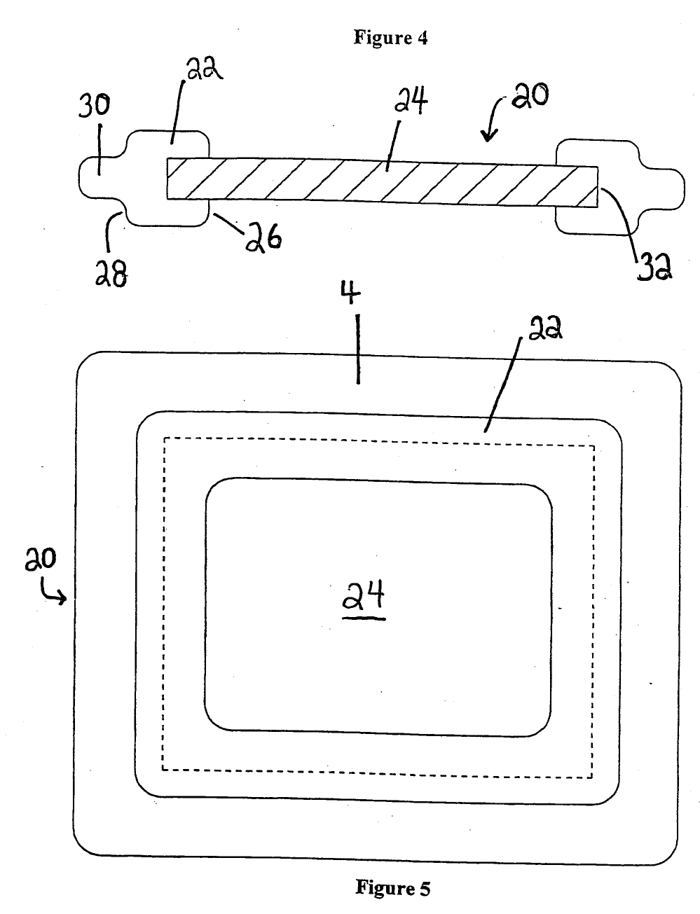

The membrane holder 22, as illustrated in FIGS. 4 and 5, is made of a hard plastic. In the preferred embodiment, the membrane holder 22 is made of a moldable thermoplastic. Any suitable material may be used, but the material must be hard enough to maintain its proportions when wedged into the vent aperture 8 and must be washable.

The membrane holder 22 as illustrated is rectangular in plan dimensions, but it can be round, oval, square, or any other shape. It consists of a sleeve with an inner wall 26 and an outer wall 28. In a simple embodiment, the membrane holder 22 can fit directly into a vent aperture 8 without a vent channel 10, and maintain its position there by an interference fit. In the preferred embodiment, however, the outer wall 28 has approximately the same dimensions as the vent channel 10 of the vent aperture 8, so that the membrane holder 22 fits snugly into the vent channel 10 and is held firmly in place by the silicone rubber of the nipple 1. The outer wall 28 preferably also has an external flange 30, of the same dimensions and shape as the vent groove 14, so that there is a tight seal between the membrane holder 22 and the nipple 1.

In the preferred embodiment, the inner wall 26 of the membrane holder 22 also has an internal channel 32, for insertion of the membrane 24. The membrane holder 22 and membrane 24 are preferably molded integrally in one operation. Alternatively, the membrane holder 22 can be molded in one piece, and have the membrane 24 inserted later, or the membrane holder 22 can be molded in two pieces for easy insertion of the membrane 24. The membrane 24 is attached to the membrane holder 22 by interference fit, nonbioreactive glue, ultrasonic sealing, heat welding, or other suitable method.

The vent 20 is placed by the user in the vent aperture 8 prior to use. The base section 4 of the nipple 1, being made of a pliable material, is easily bent for insertion of the hard disc of the vent 20. The vent 20, when in place, allows the passage of air and restricts the passage of liquids. After use, the entire apparatus can be cleaned as one piece. Alternatively, either after a single use or after a series of uses and cleansings as one piece, the vent 20 is removed from the base section 4 for separate cleaning.

Alternatively, the vent 20 can be permanently sealed within the nipple 1, and cleaned along with the rest of the nipple 1 as needed.

Because the membrane holder 22 is made of a hard material, it will hold its shape and maintain a tight seal within the vent aperture 8. It is easily removable, however, popping out of the vent aperture 8 readily upon compression of the silicon rubber of the nipple 1, and just as easily replaceable. Accordingly, the nipple 1 of the preferred embodiment provides a secure, but easily removable and washable, vent to equalize air pressure within the liquid container.

Please note that many variations can be made of this apparatus without departing from the invention. While a preferred embodiment of the present invention is shown and described, it is envisioned that those skilled in the art may devise various modifications of the present invention without departing from the spirit and scope of the appended claims.

I claim:

1. A nursing nipple comprising a teat having a vent, wherein said vent comprises a microporous membrane.

2. The nursing nipple of claim 1, wherein said membrane allows the passage of air and does not allow the passage of liquid.

3. The nursing nipple of claim 1, wherein said membrane is molded into said teat.

4. The nursing nipple of claim 1, wherein said membrane is glued into said teat.

5. The nursing nipple of claim 1, wherein said membrane is welded into said teat.

6. The nursing nipple of claim 1, wherein said membrane is secured to said teat by an interference fit.

7. A nursing nipple comprising
a teat section having a hole for the passage of nursing liquid,
a base section connected to said teat section and adapted to fit to a bottle containing said nursing liquid, and
a vent releasably attached to said base section, comprising
a microporous membrane attached to a membrane holder.

8. The apparatus of claim 7, wherein said membrane allows the passage of air and does not allow the passage of liquid.

9. The nursing nipple of claim 7, wherein said membrane is molded into said membrane holder.

10. The nursing nipple of claim 7, wherein said membrane is glued to said membrane holder.

11. The nursing nipple of claim 7, wherein said membrane is welded to said membrane holder.

12. A nursing nipple comprising
a teat section having a hole for the passage of nursing liquid,
a base section connected to said teat section and adapted to fit to a bottle containing said nursing liquid,
an aperture in said base section, having inner walls, and
a vent releasably fitted into said aperture and comprising
a microporous membrane attached to a membrane holder having outer walls,
wherein said outer walls contact said inner walls to form a seal.

13. The apparatus of claim 12, wherein said membrane allows the passage of air and does not allow the passage of liquid.

14. The nursing nipple of claim 12, wherein said membrane is molded into said membrane holder.

15. The nursing nipple of claim 12, wherein said membrane is glued to said membrane holder.

16. The nursing nipple of claim 12, wherein said membrane is welded to said membrane holder.

17. A nursing nipple comprising
a teat section having a hole for the passage of nursing liquid,
a base section connected to said teat section and adapted to fit to a bottle containing said nursing liquid,
an aperture in said base section, forming inner walls in said base section, said inner walls having a channel,
a vent releasably fitted into said aperture and comprising
a microporous membrane attached to a membrane holder having outer walls,
wherein said outer walls fit into said channel to form a seal.

18. The apparatus of claim 17, wherein said membrane allows the passage of air and does not allow the passage of liquid.

19. The nursing nipple of claim 17, wherein said membrane is molded into said membrane holder.

20. The nursing nipple of claim 17, wherein said membrane is glued to said membrane holder.

21. The nursing nipple of claim 17, wherein said membrane is welded to said membrane holder.

22. The apparatus of claim 17, further comprising a groove in said channel and a flange on said outer walls, wherein said flange fits into said channel.

23. The apparatus of claim 17, further comprising a plurality of grooves in said channel and a plurality of flanges on said outer walls, wherein said flanges fit into said grooves.

24. A nursing nipple comprising
a teat section having a hole for the passage of nursing liquid,
a base section connected to said teat section and adapted to fit to a bottle containing said nursing liquid,
an aperture in said base section, forming inner walls in said base section, said inner walls having a channel,
a vent releasably fitted into said aperture and comprising
means for allowing the passage of gas and resisting the passage of liquid, attached to a membrane holder having outer walls,
wherein said outer walls fit into said channel to form a seal.

25. The nursing nipple of claim 24, wherein said means is molded into said membrane holder.

26. The nursing nipple of claim 24, wherein said means is glued to said membrane holder.

27. The nursing nipple of claim 24, wherein said means is welded to said membrane holder.

28. The apparatus of claim 24, further comprising a groove in said channel and a flange on said outer walls, wherein said flange fits into said channel.

29. The apparatus of claim 24, further comprising a plurality of grooves in said channel and a plurality of flanges on said outer walls, wherein said flanges fit into said grooves.
